(19) United States
(12) Patent Application Publication
(10) Pub. No.: US 2005/0192948 A1
(43) Pub. Date: Sep. 1, 2005

(54) Data harvesting method apparatus and system

(76) Inventors: Joshua Justus Miller, Pittsburg, PA (US); Marcio Pugina, Orem, UT (US)

Correspondence Address: KUNZLER & ASSOCIATES, 8 EAST BROADWAY, SALT LAKE CITY, UT, 84111, US

(21) Appl. No.: 11/049,041

(22) Filed: Feb. 2, 2005

Related U.S. Application Data
(60) Provisional application No. 60/541,195, filed on Feb. 2, 2004.

(51) Int. Cl. G06F 17/30

(52) U.S. Cl. 707/3

(57) ABSTRACT

A method, apparatus, and system are disclosed for harvesting publicly accessible data from internet web pages. In one embodiment, the invention includes emulating user requests that are consistent with a user operating an industry standard browser, receiving text in response to the generated request, using a set of relevance estimators to select a most relevant candidate from a set of data items, and segmenting text received from a web page into extractable blocks. Relevance estimators may use techniques such as word matching, pattern matching, format matching, context assessment, word proximity, and the like. The extracted data may be aggregated into a database and used in applications such as phone directories or sales catalogs. The present invention facilitates data harvesting from web pages related to one or more specified topics.

### CROSS-REFERENCES TO RELATED APPLICATIONS

This application claims benefit of U.S. Provisional Patent Application No. 60/541,195 entitled “Data Harvesting Method Apparatus and System,” filed on Feb. 2, 2004, for Joshua Justus Miller and Marcio Pugina, which is incorporated herein by reference.

### BACKGROUND OF THE INVENTION

Field of the Invention

The present invention relates generally to data collection methods and systems. Specifically, the invention relates to methods, apparatus, and systems for harvesting publicly accessible data from internet web pages.

### SUMMARY OF THE INVENTION

The present invention facilitates automatically harvesting data from web pages related to one or more specified topics such as vehicles, antiques, electronics, real estate, rental property, pets, jobs, business opportunities, or the like.

In one aspect of the invention, a method for harvesting data from web pages includes emulating a user request to a web page, receiving text in response to the emulated user request, extracting data related to one or more specific topics from the received text. In one embodiment, extracting data related to a specific topic includes estimating a relevance of a data item with a set of relevance estimators including a certainty-based estimator, voting on the relevance of the data item with the set of relevance estimators, and selecting a winning candidate based on the voting.

The relevance estimators may use a variety of techniques such as word matching, pattern matching, format matching, context assessment, word-proximity, and the like. Using a plurality of relevance estimators and in particular including a certainty-base estimator increases the accuracy and utility of data extraction. The extracted data may be aggregated in a database or the like and used to generate a sales contact list or web site. For example a web site may be generated that contains a larger number of listings than the individual web sites from which the data was extracted.

In order to increase the amount of data extractable from a web page, the present invention may emulate one or more user requests. For example, the present invention may iterate through the various options and inputs accepted by one or more input controls within a form and thereby increase the amount of data retrieved from the web page. Data may also be entered into the form at user typing rates and the extracting program may emulate a browser and periodically change a source IP address.

The text received from a web page may be segmented into extractable blocks to facilitate processing. For example, a telephone number may be extracted from classified listings, or the like, and used to segment the listings into workable units. The extracted telephone number may also be used to procure additional contact information. For example, a reverse number lookup server may be accessed to identify the name and address of the person offering the listing. In particular, the zip code of a selling party may be obtained from an extracted telephone area code and/or prefix and used to compute distance information to an interested party. In similar fashion, an extracted contact name may be used to obtain a contact phone number.

The web pages from which data is extracted may be manually or automatically selected and cached at a locally accessible location. For example, a particular URL or file containing a list of URL's may be provided as the target of the extraction process. A root server may be polled for candidate web pages and particular web pages selected based on a preliminary analysis of each web page. In one embodiment, a preliminary analysis is conducted by scanning for topic-specific keywords as well as specific tags in close proximity to keywords. In certain embodiments, candidate web pages are selected by providing search results from one or more search engines.

These and other features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram depicting one embodiment of a data harvesting system of the present invention;

FIG. 2 is a block diagram depicting one embodiment of a data harvesting apparatus of the present invention;

FIG. 3 is a flow chart diagram depicting one embodiment of a data harvesting method of the present invention;

FIG. 4 is a flow chart diagram depicting one embodiment of a page relevancy assessment method of the present invention;

FIG. 5 is a flow chart diagram depicting one embodiment of a form relevancy assessment method of the present invention;

FIG. 6 is a flow chart diagram depicting one embodiment of a data extraction method of the present invention; and

FIG. 7 is a flow chart diagram depicting one embodiment of a data relevancy assessment method of the present invention.

### DETAILED DESCRIPTION OF THE INVENTION

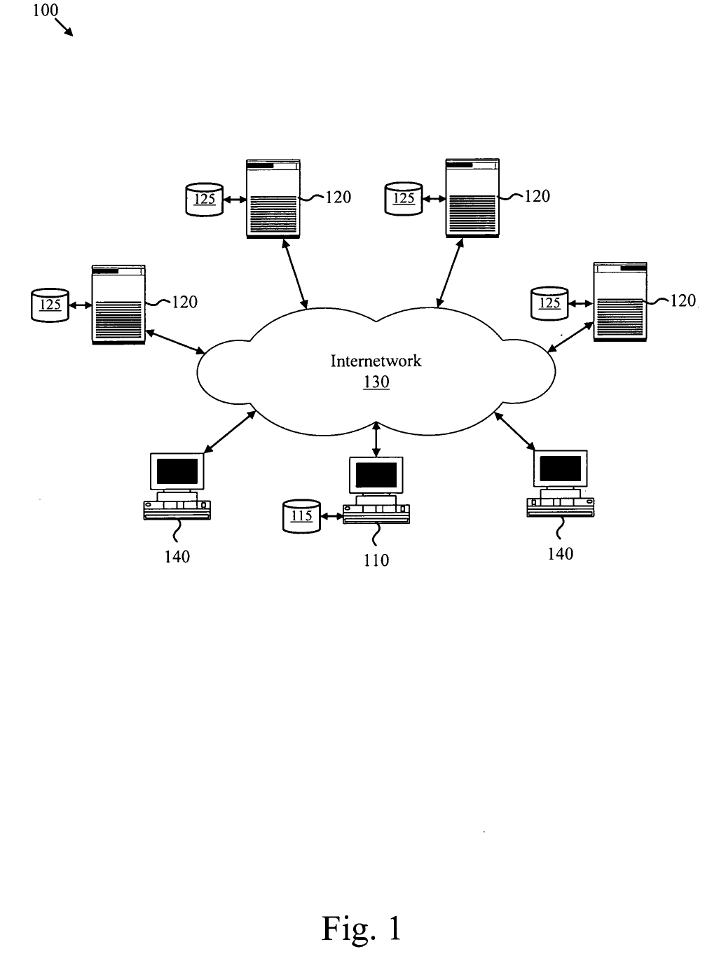

It will be readily understood that the components of the present invention, as generally described and illustrated in the Figures herein, may be arranged and designed in a wide variety of different configurations. Thus, the following more detailed description of the embodiments of the apparatus, method, and system of the present invention, as represented in FIGS. 1 through 7, is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment and the described features, structures, or characteristics may be combined in any suitable manner in one or more embodiments.

FIG. 1 is a schematic block diagram depicting one embodiment of a data harvesting system 100 of the present invention. The data harvesting system 100 includes a harvesting workstation 110 and associated aggregated database 115, one or more retailing servers 120 and associated retailing databases 125, an internetwork 130 such as the Internet, and one or more user systems 140 equipped with web browsers. In one embodiment, the data harvesting system 100 is a vehicle retailing system 100. The vehicle retailing system 100 facilitates aggregating data provided by the retailing servers 120 and other sources into the aggregated database 115 and thereby offer increased utility to users of the user systems 140.

A brick and mortar retailer may enter information directly into the aggregated database 115 describing items available for purchase. Alternately, such information may be actively provided by one of the user systems 140 or retailing servers 120. The information within the aggregated database 115 may also be augmented with data harvested from the retailing servers 120. The data harvesting system 100 increases the value of harvested information by increasing the number of listings for a particular topic available to users from a single web site. In certain embodiments, a complete web site may be generated from the data within the aggregated database 115 and uploaded to a web server to create a new retailing server 120 with more listings than the existing retailing servers 120.

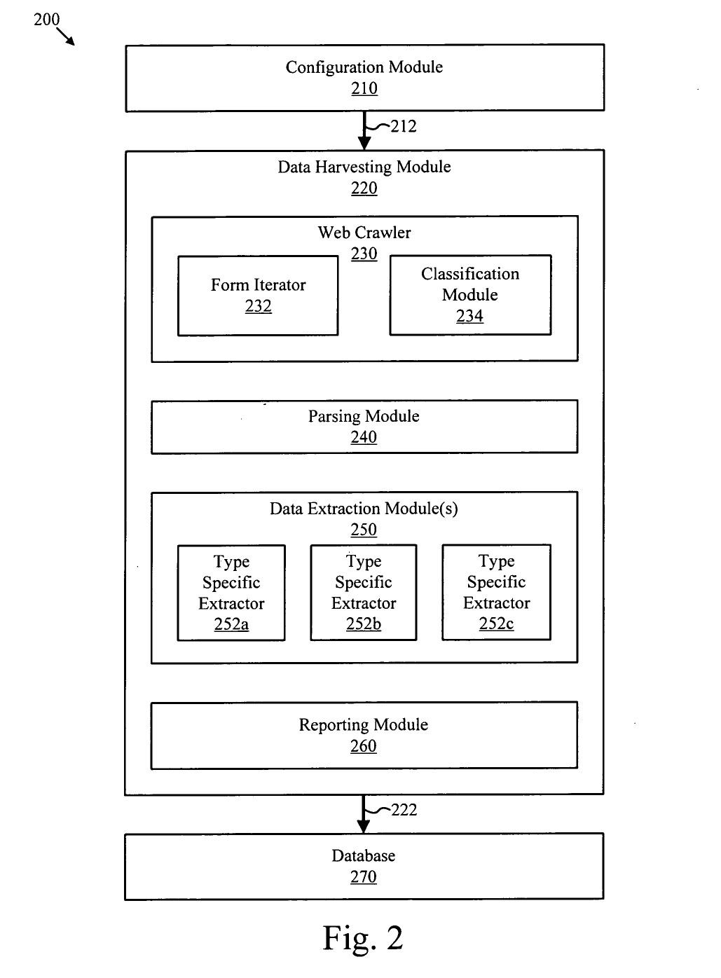

FIG. 2 is a block diagram depicting one embodiment of a data harvesting apparatus 200 of the present invention. As depicted, the data harvesting apparatus 200 includes a configuration module 210, a data harvesting module 220, and a database 270. The data harvesting apparatus 200 is one example of a harvesting workstation 110 and aggregated database 115 depicted in FIG. 1.

The modules of the data harvesting apparatus 200 may be co-located on one computing system or dispersed on multiple systems. The configuration module 210 provides configuration information 212 to the harvesting module 220. The configuration information 212 may be communicated via messages, data files, or the like. In one embodiment, the configuration module 210 is a web page. In another embodiment, the configuration module 210 is an application with a dedicated database wherein a variety of configurations are stored.

The harvesting module 220 harvests data from web sites such as those hosted by the retail servers 120 depicted in FIG. 1 as directed by the configuration information 212. The harvesting module 220 collects the desired data from specified or selected web pages, and provides the data 222 to the database 270 in a format that may be specified by the configuration information 212. In one embodiment, the harvesting module 220 may access relevant information within the retail databases 125 by emulating a user and entering data into controls within selected forms on selected web pages.

The depicted harvesting module 220 includes a variety of modules that facilitate selecting relevant web pages and associated forms, emulating a user, and generating queries that provide additional information beyond the information initially provided by the web pages presented by the retail servers 120. Those modules include a web crawler 230 with a form iterator 232 and classification module 234, a parsing module 240, a data extraction module 250 with various type specific extractors 252, and a reporting module 260.

The web crawler 230 retrieves specified or selected web pages from the retail servers 120. The web pages that are retrieved may be specified by the configuration information 212 or selected based on criteria specified within the configuration information 212. In one embodiment, the specified web pages are pages returned from a query to one or more search engines.

The classification module 234 may be used to identify and select pages or sites that may provide useful topic-specific information that can be collected and aggregated by the data harvesting apparatus 200. In one embodiment, the classification module 234 scans for topic-specific keywords as well as specific tags proximate to located keywords.

In response to identifying and retrieving one or more pages, the form iterator 232 identifies relevant forms within the retrieved pages and iterates through the options that are implicitly or explicitly accepted by the input controls within the relevant forms. In certain embodiments, form iteration is conducted in a manner that emulates a probable user. For example, options may be selected or ‘typed’ into the input controls at typical user typing rates.

The parsing module 240 receives the text returned from the web crawler 230 and parses the returned text into extractable text blocks. The returned text may include results obtained from emulated queries to a retail database 125. In one embodiment, the returned text is parsed into extractable text blocks by identifying a contact telephone number common to classified adds or the like. Using the contact telephone number as a parsing point is useful in that a contact telephone number is often positioned at or near the end of a classified listing.

The data extraction module 250 extracts relevant data from the extractable text blocks. In one embodiment, a variety of data extraction modules 250 may be provided and selectively enabled to extract data from the extractable text blocks. In the depicted embodiment, within each extraction module 250, various type specific extractors 252a-c may each extract information of a particular type from the extractable text blocks. For example, an automotive listings extractor 252a-c may include type specific extractors for automotive make, model, year, price, terms, and the like.

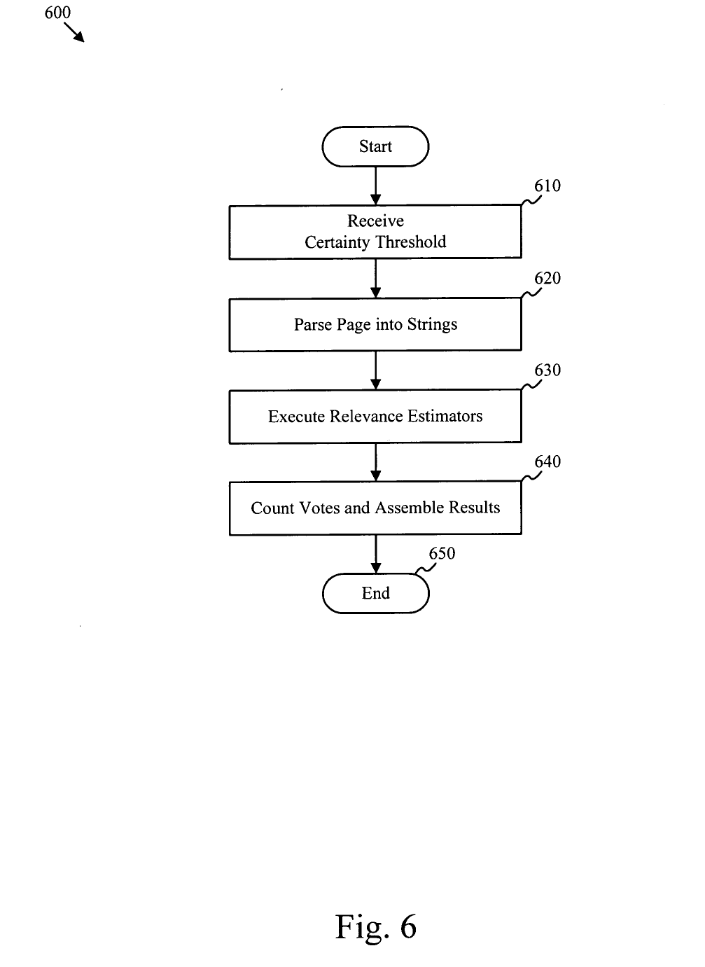

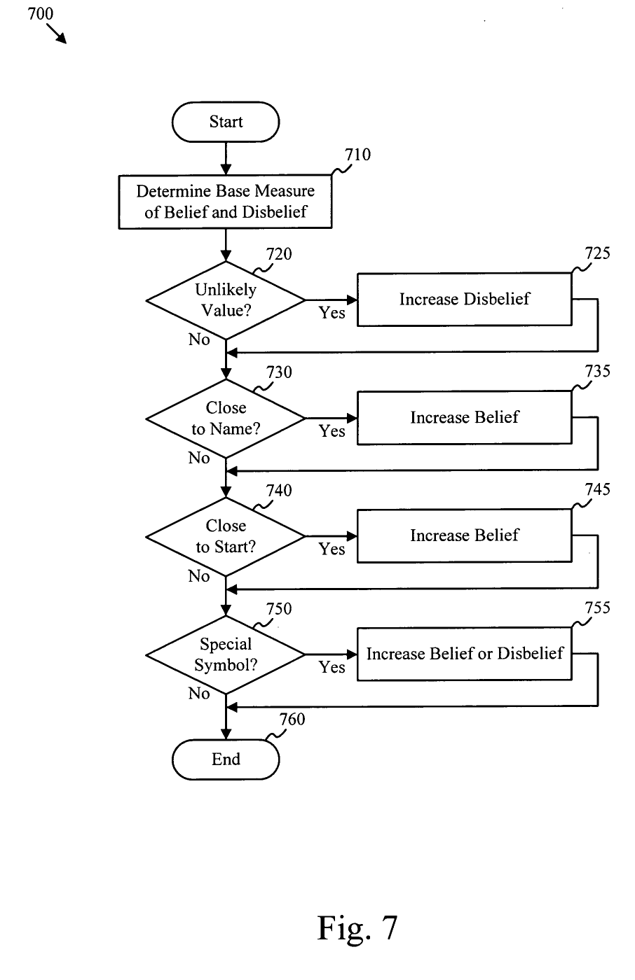

In certain embodiments, each type specific extractor comprises one or more relevance estimators such as those described in conjunction with FIGS. 6 and 7. In one embodiment, text is considered relevant and extracted for use if it is identified as relevant by a majority of the relevance estimators associated with a type specific extractor.

The reporting module 260 receives the extracted information from the data extraction module 250 and may format that information into a selected format for insertion into the database 270, or some other use. The reporting module 260 may also collect statistics or other metadata on the data received by the extraction module 250. In one embodiment, the reporting module 260 may use partial contact information to obtain additional contact information not provided by the data extraction module 250. For example, a contact phone number may be used to procure another contact phone number (or vice versa), and an extracted area code and prefix may be mapped to a zip code. In one embodiment, sales leads targeted to a specific industry or demographic profile are generated from the extracted data by the reporting module 260.

Both the metadata and data resulting from the harvesting process may be aggregated into the database 270, or the like. For example, data useful for commerce such as data related to vehicles, antiques, electronics, real estate, rental property, pets, jobs, business opportunities, and the like may be aggregated from a wide variety of web sites into the database 270.

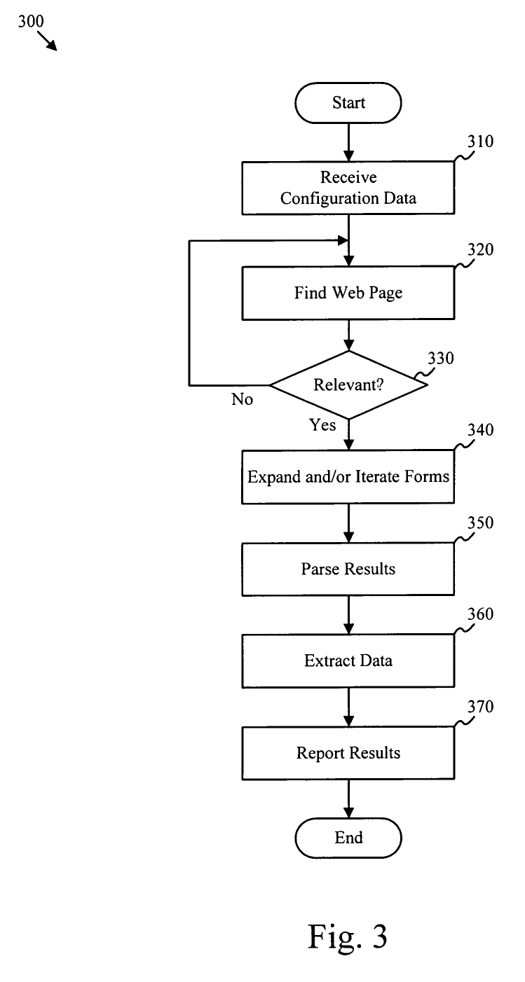

FIG. 3 is a flow chart diagram depicting one embodiment of a data harvesting method 300 of the present invention. As depicted, the data harvesting method 300 includes a receive configuration data operation 310, a find web page operation 320, a relevant test 330, an expand forms operation 340, a parse results operation 350, an extract data operation 360, and a report results operation 370. The data harvesting method 300 may be conducted in conjunction with, or independent of, the data harvesting apparatus 200.

The receive configuration data operation 310 receives configuration data related to conducting the harvesting method 300. For example, the configuration data may indicate particular web sites to process and/or particular types of data to extract. The find web page operation 320 finds a candidate web page.

The relevant test 320 ascertains whether a particular web page is relevant to one or more selected topics or classifications. In one embodiment, ascertaining if a page is relevant includes scanning for topic-specific keywords, keyword alternatives, and particular tags proximate to located keywords. If the page is not relevant, another candidate page may be found. If the page is relevant, the data harvesting method 300 proceeds to the iterate relevant forms operation 340.

The iterate relevant forms operation 340 identifies forms that may be relevant to the selected topic or topics, and iterates through the input control options in order to elicit pertinent data from a web site. For example, given an input control labeled as ‘make’ and a specified topic of ‘automobiles for sale’, the iterate relevant forms operation 340 may find the label ‘make’ within a keyword list and consequently proceed to successively enter a list of known makes of automobiles within the input control. Alternately, an input control may have a defined list of options which can be successively selected in order to iterate through the form. The input control is activated to produce results.

The parse results operation 350 receives results generated by the iterate relevant forms operation 340 and parses the results into extractable text blocks. Parsing points comprise identifiers in the results that identify the end of one extractable text block and the beginning of the next text block. In one embodiment, parsing the results involves coordinating with the iterate relevant forms operation 340. In another embodiment, specific keywords or data fields are assumed to correspond with parsing points.

The extract data operation 360 extracts data relevant to the selected topic or topics from the extractable text blocks. In one embodiment, multiple type-specific extractors are deployed such as the extractors 252a-c depicted in FIG. 2. FIG. 7 and the associated description describe a generic relevance assessment method that may be adapted to enable type-specific extraction within a data extraction module or method.

The report results operation 370 collects extracted data and associated meta-data and presents that data for viewing or subsequent use. In certain embodiments, the data is aggregated into a database.

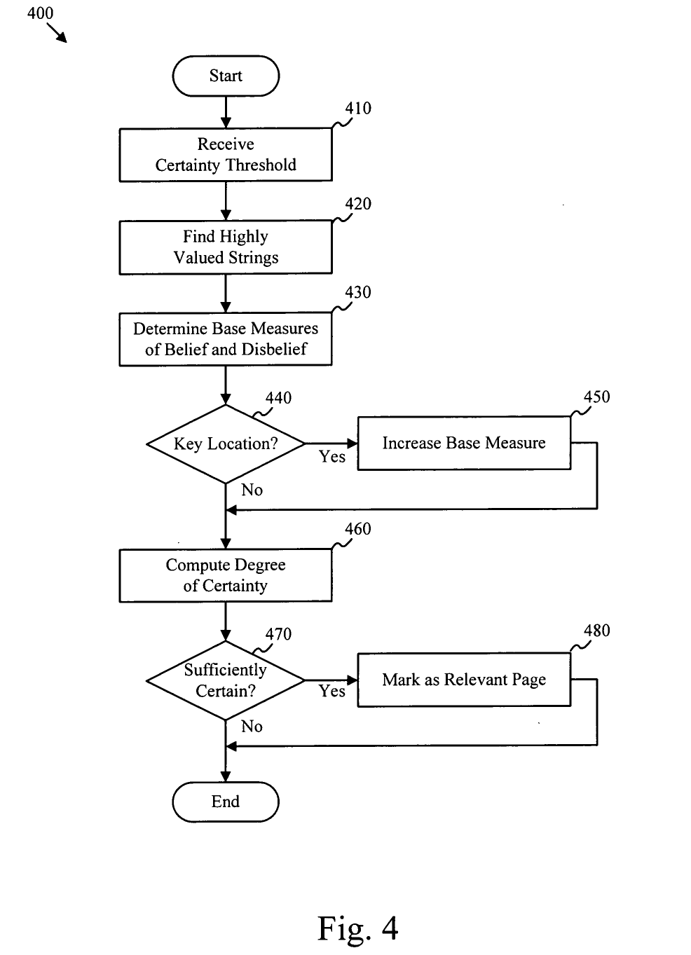

FIGS. 4-7 depict methods that use certainty mathematics and other techniques to determine pages, forms, or data items that are relevant to a selected topic. The methods track measures of belief and disbelief, i.e. certainty, that are used in the certainty calculations. Using the described methods facilitates ascertaining relevance to a particular topic using a variety of imprecise factors. Each bit of evidence contributes to the certainty that a particular hypothesis is believable or not believable.

FIG. 4 is a flow chart diagram depicting one embodiment of a page relevancy assessment method 400 of the present invention. As depicted, the method includes a receive certainty threshold operation 410, a find highly valued strings operation 420, a determine base measures operation 430, a key location test 440, an increase base measure operation 450, a compute certainty operation 460, a sufficiently certain test 470, and a mark page operation 480. The page relevancy assessment method 400 may be conducted in conjunction with, or independent of, the classification module 234 depicted in FIG. 2.

The receive certainty threshold operation 410 receives a minimum threshold value for certainty operations related to assessing the relevancy of a page. A higher threshold value requires greater certainty to evaluate a page as relevant. The find highly valued strings operation 420 finds highly valued strings within the page. In one embodiment, an alias table corresponding to a particular topic contains a list of strings including alternate spellings and abbreviations that are considered highly relevant. The highly valued strings may be associated with certain levels of belief or unbelief.

The determine base measures operation 430 assigns a base measure for each highly valued string. In one embodiment, the base measure is retrieved from the alias table. The key location test 440 ascertains whether the highly valued string is located at a key location such as within a visually emphasized region such as a page header or a bolded phrase. If the highly valued string is located at a key location, the method proceeds to the increase base measure operation 450. The increase base measure operation 450 increases the base measure of belief or unbelief associated with the highly valued string. In one embodiment, the amount of increase is a fixed amount for all strings and key locations. Of course, the amount of increase may be a user configurable amount.

The compute certainty operation 460 computes a certainty value indicating the degree of certainty that the page is relevant to one or more selected topics. In one embodiment, the degree of certainty value is computed by subtracting the sum of the unbelief measurements (for the highly valued strings of a particular topic) from the sum of the belief measurements (for the same strings) and dividing the resulting difference by the number of highly valued strings and thereafter substracting the minimum of all belief and unbelief measurements.

Subsequent to the compute certainty operation 460, the sufficiently certain test 470 ascertains whether the computed certainty is greater than or equal to the certainty threshold received in operation 410. If affirmative, the method proceeds to the mark page operation 480. The mark page operation 480 marks the page as relevant for further processing such as iterating through forms and extracting information relevant to one or more selected topics. Subsequent to the mark page operation 480, the depicted method ends.

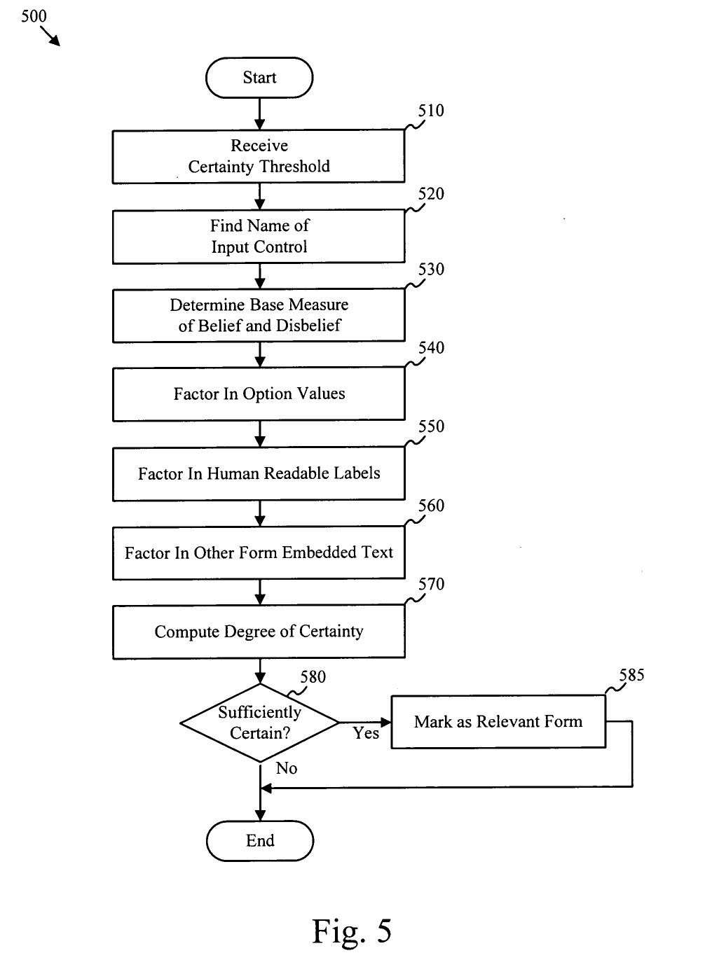

FIG. 5 is a flow chart diagram depicting one embodiment of a form relevancy assessment method 500 of the present invention. As depicted, the method includes a receive certainty threshold operation 510, a find control name operation 520, a determine base measure operation 530, a factor in option values operation 540, a factor in human readable labels operation 550, a factor in other text operation 560, a compute certainty operation 570, a sufficiently certain test 580, and a mark form operation 585. The form relevancy assessment method 500 may be conducted in conjunction with, or independent of, the form iterator 232 depicted in FIG. 2.

The receive certainty threshold operation 510 receives a minimum threshold value for certainty operations related to assessing the relevancy of a form within a selected web page. The find control name operation 520 finds the name of an input control within the form under analysis. The determine base measure operation 530 determines a base measure of belief or unbelief for the control based on the control name. In one embodiment, operation 530 accesses a table of common control names for a particular selected topic such as vehicle sales and retrieves a belief or unbelief value from the table if the control name is listed. If the control name is not listed, a default value may be used.

The factor in option values operation 540 factors in the values that may be selected for the input control to increase the belief or unbelief measures related to the form or input control. For example, if commonly used values for a particular topic area are offered as options for an input control, the measure of belief of the relevance of the form or input control may be increased. Similarly, the factor in human readable labels operation 550 and the factor in other form embedded text operation 560 conduct similar operations using, respectively, the human readable labels associated with the input control options, and other text contained within the form. In one embodiment, operation 550 and operation 560 reference an alias table for a particular topic area and increase the measure of belief or unbelief according to values contained in the alias table. The compute certainty operation 570 computes the certainty that the form is relevant to one or more selected topics.

The sufficiently certain test 580 ascertains whether the computed certainty is greater than or equal to the certainty threshold received in operation 510. If affirmative, the method 500 proceeds to the mark form operation 585. The mark form operation 585 marks the page as relevant for further processing such as iterating through the form and extracting information relevant to one or more selected topics. Subsequent to the mark form operation 585, the depicted method ends 590.

FIG. 6 is a flow chart diagram depicting one embodiment of a data extraction method 600 of the present invention. As depicted, the method 600 includes a receive certainty threshold operation 610, a parse page operation 620, an execute relevance estimators operation 630, and a count votes operation 640. The data extraction method 600 may be conducted in conjunction with, or independent of, the data extraction module 250 depicted in FIG. 2.

The receive certainty threshold operation 610 receives a minimum threshold value for certainty operations related to assessing the relevancy of data within a selected web page. The parse page operation 620 parses the selected web page into strings. In one embodiment, white space characters and markup tags may identify the ends of strings.

The execute relevance estimators operation 630 executes a set of relevance estimators on the data strings. Examples of relevance estimators include a word match estimator, a pattern match estimator, a word context estimator, a certainty estimator, and the like. In one embodiment, each type of relevance estimator includes a result structure that is private to the relevancy estimator. In one embodiment, the private result structure provides working space to process raw candidate strings or strings provided by processing raw candidate strings with a relevancy algorithm and/or a pre-processing algorithm. Candidates to fulfill each field in a results structure may be put forward by one or more relevance estimators.

The count votes operation 640 counts the number of votes for each candidate and selects winning candidate strings. In one embodiment, the count votes operation 640 compiles a master results structure based on many private result structures to determine the number of votes for a candidate. In one embodiment, winning requires a majority of votes. In certain embodiments, each relevance estimator votes only for candidate strings that have a measure of certainty greater than or equal to the minimum certainty threshold receive in operation 610. In some embodiments, fields without a winner may remain unfilled in the results structure. Subsequent to the count votes operation 640 the method ends 650.

FIG. 7 is a flow chart diagram depicting one embodiment of a data relevancy assessment method 700 of the present invention. As depicted, the method includes a determine base measure operation 710, an unlikely value test 720, an increase disbelief operation 725, a close to name test 730, an increase belief operation 735, a close to start test 740, an increase belief operation 745, a special symbol test 750, and an increase belief or disbelief operation 755. The data relevancy assessment method 700 is a generic example of the operations conducted by a certainty-based relevance estimator and may be adapted to the needs of particular types of data. For example, the method 700 may be invoked in conjunction with operation 630 depicted in FIG. 6.

The determine base measure operation 710 determines a base measure for a data item such as a parsed string from a web page. In one embodiment, the determine base measures matches the data item with a table of known values and aliases. In another embodiment, operation 710 matches the data item with one or more valid formats or patterns and assigns a corresponding base measure to the data item. A base measure is an initial measure of the relevancy. Low base measures may be less relevant than high base measures.

The unlikely value test 720 ascertains whether the data item is outside a range of reasonable values. If the data item is outside the range of reasonable values the method proceeds to the increase disbelief operation 725. The increase disbelief operation 725 increases the amount of disbelief that the data item is relevant to the selected topic.

The close to name test 730 ascertains whether the data item is located close to a desired name or label. If the data item is close to a desired name or label, the method proceeds to the increase belief operation 735. The increase belief operation 735 increases the <amount of belief that the data item is relevant to the selected topic.

Similar to the close to name test 730, the close to start test 740 ascertains whether the data item is located close to the start of the form or page being processed. If the data item is close to the start, the method proceeds to the increase belief operation 745. The increase belief operation 745 increases the amount of belief that the data item is relevant to the selected topic.

The special symbol test 750 ascertains whether the data item contains or is near a special symbol. If affirmative, the method proceeds to the increase belief or disbelief operation 755. The increase belief or disbelief operation 755 increases the amount of belief or disbelief depending on whether the special symbol is associated or disassociated with the topic at hand. Subsequent to operation 755 the method ends 760.

The preceding methods are intended to exemplify in a generic manner, a variety of factors that may influence the relevance of data, forms, and web pages to a selected topic. One of skill in the art will appreciate that the depicted methods may be adapted to the needs of a particular application.

In summary, the present invention facilitates harvesting data from web sites such as retailing web sites. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for harvesting data from web pages, the method comprising:
generating a plurality of emulated user requests that are consistent with a user operating an industry standard browser;
receiving text in response to the emulated user requests; and
extracting data related to a specific topic from the received text.

2. The method of claim 1, wherein extracting data comprises estimating a relevance of a data item with a plurality of relevance estimators including a certainty-based estimator.

3. The method of claim 2, further comprising voting on the relevance of the data item with the plurality of relevance estimators.

4. The method of claim 2, wherein a relevance estimator of the plurality of relevance estimators is selected from the group consisting of a word match estimator, a pattern match estimator, and a context estimator.

5. The method of claim 4, wherein the context estimator is proximity sensitive.

6. The method of claim 1, further comprising segmenting the received text in response to extracting a telephone number.

7. The method of claim 1, further comprising using an extracted phone number to procure additional contact information.

8. The method of claim 1, further comprising using a contact name to procure a phone number.

9. The method of claim 1, further comprising mapping an extracted area code and prefix to a zip code.

10. The method of claim 1, wherein extracting data comprises scanning for topic-specific words.

11. The method of claim 10, wherein scanning for topic-specific words comprises scanning for alternate spellings.

12. The method of claim 10, wherein scanning for topic-specific words comprises referencing an alias table.

13. The method of claim 12, wherein the alias table comprises word abbreviations.

14. The method of claim 12, further comprising updating the alias table.

15. The method of claim 1, further comprising iterating through a form via a plurality of emulated user requests.

16. The method of claim 1, further comprising generating sales leads from the extracted data.

17. The method of claim 1, wherein emulating the user request comprises entering data into a form.

18. The method of claim 1, wherein emulating the user request comprises entering data at user typing rates within a control.

19. The method of claim 1, wherein emulating the user request comprises changing a source IP address.

20. The method of claim 1, further comprising selecting the web page.

21. The method of claim 21, wherein selecting the web page comprises polling a root server.

22. The method of claim 21, wherein selecting the web page comprises emulating a DNS server.

23. The method of claim 21, wherein selecting the web page comprises scanning for topic-specific keywords.

24. The method of claim 21, wherein selecting the web page comprises scanning for specific tags proximate to located keywords.

25. The method of claim 21, wherein selecting the web page comprises receiving a user-specified URL.

26. The method of claim 21, wherein selecting the web page comprises providing results from at least one search engine.

27. The method of claim 1, further comprising caching the web page to a locally accessible location.

28. The method of claim 1, further comprising programmatically splitting an image from the web page.

29. The method of claim 1, further comprising generating a sales contact list.

30. The method of claim 1, further comprising protecting private information for a seller.

31. The method of claim 1, further comprising aggregating data from a plurality of web sites related to items available for sale, the items available for sale selected from the group consisting of vehicles, antiques, electronics, real estate, rental property, pets, jobs, rental property, and business opportunities.

32. The method of claim 32, wherein aggregating data comprises adding data to a database.

33. The method of claim 32, further comprising automatically generating a web site from the aggregated data.

34. An apparatus for harvesting data from web pages, the apparatus comprising:
a web crawler configured to generate a plurality of emulated user requests that are consistent with a user operating an industry standard browser;
a parsing module configured to receive text in response to the emulated user requests; and
a plurality of data extraction modules configured to extract data related to a specific topic from the received text.

35. The apparatus of claim 34, further comprising a plurality of relevance estimators configured to vote on a relevance of a data item.

36. The apparatus of claim 35, wherein the plurality of estimators comprises a certainty-based estimator configured to receive relevance estimates from the other relevance estimators and provide an additional vote on the relevance of a data item.

37. A system for harvesting data from web pages, the system comprising:
a server comprising a web crawler configured to generate a plurality of emulated user requests that are consistent with a user operating an industry standard browser, a parsing module configured to receive text in response to the emulated user requests, and a plurality of data extraction modules configured to extract data related to a specific topic from the received text;
a database configured to store extracted data; and
a communications link configured to provide operable connect the server to an internetwork.
